(19) United States
(12) Patent Application Publication
(10) Pub. No.: US 2012/0120881 A1
(43) Pub. Date: May 17, 2012

(54) SUBCARRIER ALLOCATION FOR DOWNLINK CHANNELS IN AN ORTHOGONAL FREQUENCY DIVISION MULTIPLEX (OFDM) COMMUNICATION SYSTEM

(76) Inventor: Amit KALHAN, San Diego, CA (US)

(21) Appl. No.: 12/946,776

(22) Filed: Nov. 15, 2010

(51) Int. Cl. H04W 72/04

(52) U.S. Cl. 370/329

(57) ABSTRACT

By managing power weighting of the subcarriers, one or more subcarrier frequencies are used for simultaneous downlink transmission by base stations having at least partially overlapping service areas in an orthogonal frequency division multiplex (OFDM) communication system. For one implementation, the communication system includes large service area (LSA) base stations having LSA geographical service areas and small service area (SSA) base stations having SSA geographical service areas that are smaller than the LSA geographical service areas and may at least partially overlap with the LSA geographical service areas. The base stations are arranged and configured to provide wireless communication service to mobile wireless communication devices within the service areas using orthogonal frequency division multiplex (OFDM) techniques where signals are transmitted over a plurality of subcarriers. Subcarriers with lower power weightings are assigned to mobile wireless communication devices having channel quality above a threshold and subcarriers with higher power weighting are assigned to mobile wireless communication devices having channel quality below the threshold.

### BACKGROUND

The invention relates in general to wireless communication systems and more specifically to allocation of subcarriers for downlink channels in an orthogonal frequency division multiplex (OFDM) communication system.

Base stations in cellular communication systems provide communications services to wireless communication devices within geographical cells where each base station exchanges signals with wireless communication devices within an associated cell. The size and shape of each cell and, therefore, the coverage area of the base station are determined by several factors and are at least partially based on design parameters of the base station. In addition to large macro cells that provide services to numerous devices within relatively large geographical areas, some cellular communication systems are increasingly employing smaller cells to increase efficiency, improve coverage, improve the quality of service, and provide additional services. The smaller cells may include a variety of sizes typically referred to as microcells, picocells and femtocells. Microcells and picocells are often implemented within office buildings, shopping centers and urban areas in order to provide additional security, higher user capacity for the area, additional service features, and/or improved quality of service. Femtocells have relatively smaller geographical areas and are typically implemented at residences or small office locations. Since typical cellular backhaul resources may not be available in these locations, femtocells are sometimes connected to the cellular infrastructure through DSL or cable modems. Femtocells are part of the cellular network and, therefore, communicate with the wireless devices using the same techniques as those used by macrocells. The proximity of the various base stations and wireless communication devices often results in interference. In addition to interference of data communications, control channels may also suffer performance degradation due to interference.

### SUMMARY

By managing power weighting of the subcarriers, one or more subcarrier frequencies are used for simultaneous downlink transmission by base stations having at least partially overlapping service areas in an orthogonal frequency division multiplex (OFDM) communication system. For one implementation, the communication system includes large service area (LSA) base stations having LSA geographical service areas and small service area (SSA) base stations having SSA geographical service areas that are smaller than the LSA geographical service areas and at least partially overlap with the LSA geographical service areas. The base stations are arranged and configured to provide wireless communication service to mobile wireless communication devices within the service areas using orthogonal frequency division multiplex (OFDM) techniques where signals are transmitted over a plurality of subcarriers. Subcarriers with lower power weightings are assigned to mobile wireless communication devices having channel quality above a threshold and subcarriers with higher power weighting are assigned to mobile wireless communication devices having channel quality below the threshold. In some circumstances where the subcarriers are used for downlink data (and voice), the power weightings of subcarriers are based on a quality of service (QoS) of the application used by a mobile wireless communication device.

### BRIEF DESCRIPTION OF THE DRAWINGS

FIG. 1A is a block diagram of an OFDM communication system where two base stations with at least partially overlapping geographical service areas transmit subcarriers at the same frequency.

FIG. 1B is a diagram of an example of the orthogonal frequency division multiplex (OFDM) communication system service area deployment having a plurality of geographical service areas provided by several base stations.

FIG. 2A is a graphical representation of an example of subcarrier transmissions from a LSA base station and SSA base stations having at least partially overlapping geographical service areas with the LSA geographical service area.

FIG. 2B is a graphical representation of an example of subcarrier transmissions from a LSA base station and the SSA base stations having at least partially overlapping geographical service areas with the LSA geographical service area where each base station can simultaneously transmit subcarriers within all frequency sets.

FIG. 3 is a graphical illustration of transmissions from the base stations where the downlink subcarriers are managed for transmission of control information.

FIG. 4 is a flow chart of an example of a method for managing transmission of subcarriers from multiple base stations within an OFDM communication system.

### DETAILED DESCRIPTION

The exemplary embodiments discussed below provide efficient assignment of subcarrier frequencies for downlink transmission in heterogeneous network systems where mobile wireless communication devices are capable of receiving downlink signals from multiple base stations. A power management scheme is applied to reduce interference from base stations having overlapping or proximate geographical service areas to reduce interference, allow frequency reuse, and increase the resource efficiency. A downlink scheduler assigns subcarriers in a first frequency set at a first power weighting for downlink transmissions to a mobile wireless communication device from a first base station and subcarriers in another frequency at another power weighting for other downlink transmissions to another mobile wireless communication device from the base station where the first power weighting is less than the second power weighting. Subcarriers within the first frequency set are also assigned for transmissions to a second mobile wireless communication device from a second base station having a geographic service area that at least partially overlaps the geographical service area of the first base station. Subcarriers with higher power weightings are assigned to mobile wireless communication devices having a lower quality communication channels and subcarriers with lower power weightings are assigned to mobile wireless communication devices having a higher quality communication channels with the base station. By shifting power away from subcarriers that are being used for mobile wireless communication devices having good quality channels, the mobile wireless communication devices can still receive the subcarriers while allowing the frequency of the subcarriers to be reused by another base station that has an overlapping service area. In addition to applying the scheme to control channels, the techniques may be used for downlink data transmissions. For data communication, the power weighting of subcarriers is further based on a requested or required Quality of Service (QoS) for the particular communication with a mobile wireless communication device.

As discussed below in further detail, these techniques can be applied to a heterogeneous system having larger service area (LSA) base stations and smaller service area (SSA) base stations deployed within the same geographical region where the power weightings for the subcarriers transmitted by the base stations are selected based on the relative locations of the base stations and desired channel characteristics. The SSA base stations within the coverage areas of an LSA base station can simultaneously transmit subcarriers using the same frequencies used by the LSA base station. Accordingly, the service can be provided by one layer of base stations such as macro eNodeBs and by second layer of base stations such as pico eNodeBs within the same geographical area to efficiently provide ubiquitous wireless communication service throughout the area.

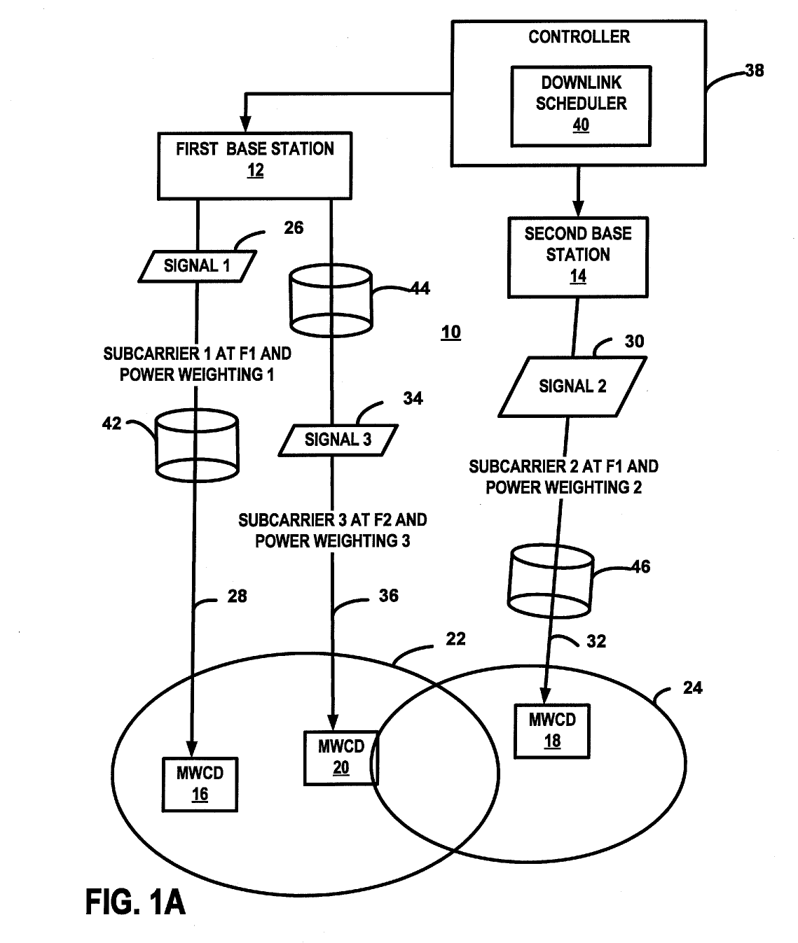

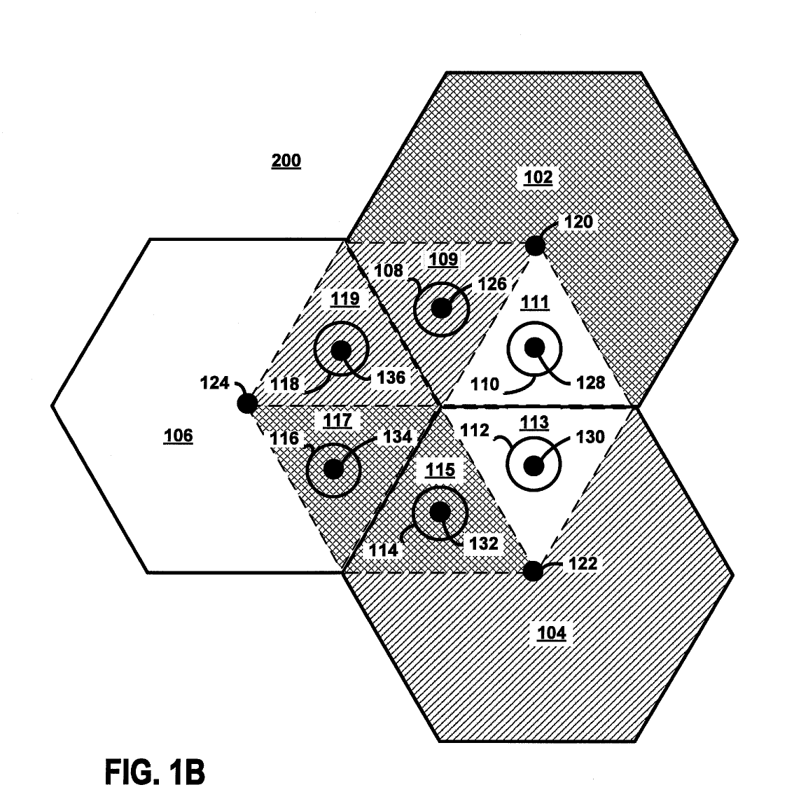

FIG. 1A is a block diagram of an orthogonal frequency division multiplex (OFDM) communication system 10 including at least two base stations 12, 14. For the examples discussed below, the system 10 operates in accordance with an orthogonal frequency division multiplex (OFDM) standard. The various functions and operations of the blocks described with reference to the communication system 10 may be implemented in any number of devices, circuits, and/or elements as well as with various forms of executable code such as software and firmware. Two or more of the functional blocks in the figures may be integrated in a single device and the functions described as performed in any single device may be implemented over several devices.

The system 10 includes at least two base stations 12, 14 and a wireless communication device. In most circumstances, several base stations are connected to a network controller through network infrastructure to provide wireless communication services to multiple wireless communication devices 16, 18, 20.

The mobile wireless communication devices 16, 18, 20 may be referred to as mobile devices, wireless devices, wireless communication devices, and mobile wireless devices as well as by other terms. The wireless communication devices 16, 18, 20 include electronics and code for communicating with the base stations and include devices such as cell phones, personal digital assistants (PDAs), wireless modem cards, wireless modems, and laptop computers as well as other devices.

For identification purposes, the base stations are referred to as a first base station 12 and a second base station 14. The base stations 12, 14 include wireless transceivers that exchange wireless signals with the wireless communication devices 16, 18, 20. Transmissions from the base stations and from the wireless communication devices are governed by a communication specification that defines signaling, protocols, and parameters of the transmission. The communication specification may provide strict rules for communication and may also provide general requirements where specific implementations may vary while still adhering to the communication specification. Although the discussion below is directed to the 3GPP Long Term Evolution (LTE) communication specification, other communication specifications may be used in some circumstances. The communication specification defines at least a data channel and a control channel for uplink and downlink transmissions and specifies at least some timing and frequency parameters for physical downlink control channels from a base station to a wireless communication device. The control channel includes a logical broadcast control channel as well as device-specific logical control channels.

The mobile communications with a base station may include data communications and control information and may include downlink transmissions to mobile communication devices associated with the base station (serving base station) as well as mobile communication devices not yet associated with the base station (non-serving base station). All mobile communication devices are registered with the network for the examples discussed herein. For example, a mobile communication between the first base station 12 and a mobile communication device 16 may include a resource description of a time-frequency resource carrying particular control information required by a mobile communication device entering the service area (not shown in FIG. 1A) to acquire service from the first base station 12.

Each base station 12, 14 provides wireless communication services to mobile wireless communication devices 16, 18, 20 within a geographical service area 22, 24 using OFDM techniques. A first base station 12, provides wireless service to a first mobile wireless communication device 16 and a third mobile wireless communication device 20 positioned within a first geographical service area 22. A second base station 14 provides wireless service to a second mobile wireless communication device 18 within a second geographical service area 24. The first base station 12 can provide wireless communication services to mobile wireless communication devices anywhere within the first geographical service area 22 and the second base station 14 can provide wireless communication services to mobile wireless communication devices anywhere within the second geographical service area 24. For the examples discussed herein, the system 10 is a heterogeneous system where the base stations operate within two or more communication networks. For example, a macro network such a cellular network may provide wireless service within macrocells while a micro network or pico network, such a Wireless Local Area Network (WLAN), may provide service within micro cells or pico cells that overlap with one or more macro cells. Accordingly, for the example of FIG. 1A, the first geographic service area 22 at least partially overlaps with the second geographic service area 24. In some situations, one or more of the geographic service areas may be completely within another geographic service area.

Since the system 10 operates in accordance with OFDM techniques, downlink signals are transmitted over a plurality of subcarriers within a frequency band. The frequency band is divided into a large number of closely-spaced orthogonal subcarriers. Information is divided into several parallel data streams or channels, one for each sub-carrier. For the example, each subcarrier is modulated with a conventional modulation scheme. A physical channel can be defined by allocating specific frequency-time resources where transmissions are allocated at particular times and over particular subcarriers or groups of subcarriers. The granularity of these resources depends on the specification and design of the system.

In conventional systems, base stations with overlapping service areas do not simultaneously transmit using the same subcarrier frequencies. In some conventional heterogeneous systems with multiple overlapping networks, each network uses a different frequency band for downlink subcarrier transmission to avoid interference. These systems are typically referred to as multi-carrier systems and differ from OFDM systems in that subcarriers can be separately transmitted rather than transmitted as part of signal OFDM transmission that uses multiple orthogonal subcarriers. With OFDM, the members of an orthogonal basis set are applied to the subcarriers within a frequency band to provide the set of orthogonal subcarriers within the band. Typically, all subcarriers within the band are transmitted.

In the examples discussed herein at least some of the subcarrier frequencies are used by multiple overlapping networks since both networks are transmitting OFDM signals that use the same (or at least overlapping) subcarrier frequencies. The simultaneous transmission of subcarriers with the same frequency from base stations with overlapping service areas is facilitated with downlink transmission power management. As described in further detail below, power weighting is applied to reduce power of subcarriers from one base station so the subcarriers can be reused by another base station having an overlapping service area. For the examples discussed below, the power is reduced for subcarriers transmitted from the base station having the larger service area. In some circumstances, however, a power management scheme may be used where the power of subcarriers transmitted from the base station having the smaller service area is reduced.

Continuing with the example of FIG. 1A, the first base station 12 transmits a first signal 26 to the first mobile wireless communication device 16 using at least a first subcarrier 28 having a first frequency (F1). In a typical situation, multiple subcarriers are used to transmit the first signal 26. In such situations, therefore, one of the subcarriers has a center frequency of F1. The first subcarrier 28 has a power weighting, P1. As described below, a power loading scheme is used to allocate power across the subcarriers. In accordance with OFDM techniques, power is allocated using power-loading techniques where power is increased over some subcarriers and decreased over others while maintaining a constant energy over the full frequency band.

The second base station 14 transmits a second signal 30, to the second mobile wireless communication device 18, over a second subcarrier 32 at the same frequency (F1) as the first subcarrier 28. A second power weighting (P2) is applied to the second subcarrier 32. The second signal 30 may be transmitted over several subcarriers where one of the subcarriers is the second subcarrier 32.

The signals may be data signals or control signals. As discussed below, however, the techniques may be most suitable for control signals since control channels typically have a fixed coding rate and modulation order.

In some circumstances, the power weightings (P1, P2) are established such that the maximum interference caused by either of the signals 26, 30 to reception of the other signal by the intended mobile wireless communication device is below a threshold allowing successful reception by that device. Therefore, the power weighting (P1) of the first subcarrier is sufficiently low to maintain the interference caused by the first subcarrier to a low enough level to allow the second mobile wireless communication device 18 to receive the second subcarrier. For the example, the first base station 12 also transmits a third signal 34 over a third subcarrier 36. The frequency for the third subcarrier 36 is a second frequency (F2) different from the first frequency (F1).

The base stations 12, 14 are connected to a controller 38 that manages at least some of the operational parameters of the system 10. The controller 38 is any combination of hardware, software and/or firmware that performs the described functions. The controller 38 may be located in one of the base stations 12, 14, in the core network (not shown), or may be distributed over the core network and/or base stations 12, 14. Accordingly, one or more devices that may or may not be collocated may perform the functions described as performed by the controller. For the example, the controller 38 is within the core network and communicates with the base stations 12, 14 in accordance with known techniques.

The controller 38 performs downlink scheduling. Hardware and software form a downlink scheduler 40 that assigns subcarrier frequencies and power weightings to the base stations 12, 14 and mobile wireless communication devices 16, 18, 20. The downlink scheduler 40 may be static, dynamic or semi-static. For example, a set of subcarrier frequencies and or power weightings may be allocated to the base stations at the time of system deployment and are not changed. In other situations, the subcarrier frequencies and power weighting may be reassigned during operation based on current conditions. In other circumstances, some parameters are static and others can be dynamically changed. For example, a particular frequency assignment to the base stations may be static while the power weighting may be adjusted based on conditions or application requirements or requests.

For the example of FIG. 1A, the downlink scheduler 40 identifies mobile wireless communication devices 16 that are communicating with the first base station 12 through a high quality channel 42 and assigns the first frequency subcarrier 28 at the reduced power weighting (P1). The quality of the channel 42 may be determined using any known techniques such as signal to noise ratio (SNR) and bit error rate (BER) measurements. The same subcarrier frequency (F1) can be assigned to the second base station 14 since the lower power weighting of the first subcarrier 28 will allow both signals 26, 30 to be transmitted without detrimental interference. Assignment of subcarrier frequencies may depend on the quality of the channels 44, 46 used for transmitting the second signal 30 and the third signal 34.

Therefore, the orthogonal frequency division multiplex (OFDM) communication system comprises a plurality of base stations configured to transmit downlink signals over a plurality of subcarriers. The plurality of base stations include at least a first base station having a first geographical service area and a second base station having a second geographical service area that at least partially overlaps the first geographical service area. The first base station is configured to transmit a first signal over a first subcarrier at a frequency. The second base station is configured to transmit, simultaneously to the transmission of the first subcarrier, a second signal over a second subcarrier at the frequency. The first subcarrier is transmitted by the first base station at a power weighting less than another power weighting of another subcarrier transmitted by the first base station. The downlink scheduler in the controller is configured to assign the first subcarrier for transmissions to a mobile wireless communication device having a channel quality of a channel between the mobile wireless communication device and the first base station that is above a threshold. The downlink scheduler is also configured to assign the other subcarrier having a different frequency for transmissions to another mobile wireless communication device where the channel quality of the channel between the other mobile wireless communication device and the first base station is below the threshold.

In some circumstances where the downlink communication is a data communication, the assignment of subcarriers and subcarrier power weightings is further based on the required and/or requested QoS of the application of the particular mobile wireless communication device. For example, where one mobile wireless communication device is running a voice application requiring a first QoS level and another mobile wireless communication device is running a data application requiring a second QoS level, power weighting of the subcarriers transmitting the voice application may be different than the power weighting of the subcarriers transmitting the data application signals even though both of the mobile wireless communication devices are served by the same base station. In some circumstances, other factors are used to determine power-weightings. Such factors may include the number of subcarriers assigned to a mobile wireless communication device (bandwidth extension), a coding rate, a modulation order, a MIMO mode, and others. Applying these other factors is complementary to the above scheme.

FIG. 1B is a diagram of an example of the orthogonal frequency division multiplex (OFDM) communication system service area deployment 100 having a plurality of geographical service areas 102, 104, 106, 108, 110, 112, 114, 116, 118 provided by several base stations 120-136. The system deployment 100, therefore, is one example of deployment for the system 10 shown in FIG. 1A. The hexagonal blocks (102, 104, 106) represent large service area (LSA) service areas and the circles (108, 110, 112, 114, 116, 118) represent small service area (SSA) geographical service areas. The triangles (109, 111, 113, 115, 117, 119) represent regions within the SSA service areas where SSA base stations are deployed. The blocks do not necessarily depict the actual shapes of the service areas since the service areas typically will not have perfect geometric shapes. FIG. 1B, therefore, illustrates the general relationships between the service areas and is not necessarily to scale. The SSA service areas (108, 110, 112, 114, 116, 118) may have any shape and size which allows the SSA service area to fit within the corresponding SSA region (109, 111, 113, 115, 117, 119). Accordingly, as an extreme case, the perimeter of a SSA service area may coincide with the shape of the SSA region within which it is located.

An example of a heterogeneous network system that includes multiple sized and overlapping service areas includes systems that operate in accordance with 3GPP LTE communication specification and include one or more of macrocells, microcells, picocells and femtocells. In such systems, the base stations are typically referred to as eNodeBs. A larger service area (LSA) eNodeB, such a macro eNodeB has a larger service area than a smaller service area (SSA) eNodeB such as a Micro eNodeB, Pico eNodeB, or Femto eNodeB. As discussed herein, a larger service area (LSA) base station is any type of base station or eNodeB that provides communication services within a larger service area than a smaller service area (SSA) base station where the SSA base station is any type of base station or eNodeB providing service within the smaller geographical service area.

The service regions 109, 111, 113, 115, 117, 119 are portions of the LSA service areas 102, 104, 106. Each of the LSA service area 102, 104, 106 can be defined to have additional portions not shown in FIG. 1B. The service regions may correspond to sectors of a LSA base station. For example, therefore, if the LSA base station 102 is a Macro eNodeB with smart antennas, the service region 109 may coincide with the service area of one of the sectors and the SSA base station 126 may be a Pico eNode B providing a service area 108 within the service region 109.

The first LSA base station 120 can provide wireless communication services to mobile communication devices within the first LSA geographical service area 102, the second LSA base station 122 can provide wireless communication services to mobile communication devices within the second LSA geographical service area 104, and the third LSA base station 124 can provide wireless communication services to mobile communication devices within the third LSA geographical service area 106. The first SSA base station 126 can provide wireless communication services to mobile communication devices within the first SSA geographical service area 108, the second SSA base station 128 can provide wireless communication services to mobile communication devices within the second SSA geographical service area 110, the third SSA base station 130 can provide wireless communication services to mobile communication devices within the third SSA geographical service area 112, the fourth SSA base station 132 can provide wireless communication services to mobile communication devices within the fourth SSA geographical service area 114, the fifth SSA base station 134 can provide wireless communication services to mobile communication devices within the fifth SSA geographical service area 116, and the sixth SSA base station 136 can provide wireless communication services to mobile communication devices within the sixth SSA geographical service area 118. The first SSA geographical service area 108 may be anywhere within the first SSA region 109, the second SSA geographical service area 110 may be anywhere within the second SSA region 111, the third SSA geographical service area 112 may be anywhere within the third SSA region 113, the fourth SSA geographical service area 114 may be anywhere within the fourth SSA region 115, the fifth SSA geographical service area 116 may be anywhere within the fifth SSA region 117 and the sixth SSA geographical service area 118 may be anywhere within the sixth service SSA region 119. Also, each of the SSA regions may include several SSA base stations.

As discussed above, in OFDM systems, a frequency band is divided into a large number of closely-spaced orthogonal sub-carriers. Information is divided into several parallel data streams or channels, one for each sub-carrier. The subcarrier allocation of FIG. 1B includes several examples of the system 10 described with reference to FIG. 1A. For example, the first LSA base station 120 is an example of the first base station 12 of FIG. 1A and both the first SSA base station 126 and the second SSA base station 128 are examples of the second base station 14 of FIG. 1A. Therefore, in accordance with this exemplary embodiment, subcarriers assigned for transmission from the LSA base station 120 are also assigned to one or more SSA base stations 126, 128, having service areas 108, 110 that at least partially overlap with the LSA service area 102 of the LSA base station 120. The service areas 108, 110 are deployed within service regions 109, 111 which are portions of the LSA service area 102. As discussed above, the subcarriers transmitted by the LSA base station 120 have low power weightings and are used for mobile communication devices that communicate with the LSA base station through a relatively high quality communication channel. Due to the good channel conditions, the relatively low power weighting can be used for the subcarriers transmitted from the LSA base station. As a result, mobile devices receiving subcarriers transmitted from the SSA base station do not experience significant interference from the subcarriers transmitted from the LSA base station.

FIG. 1B illustrates one example of subcarrier allocation to LSA base stations and SSA base stations. As discussed above, systems that operate in accordance with a 3GPP LTE communication specification are examples of heterogeneous network systems that included multiple sized and overlapping service areas and may include one or more of macrocells, microcells, picocells and femtocells. Continuing with the examples of FIG. 1A and FIG. 1B, therefore, the LSA base stations (first base station 12) may be eNodeBs with geographical service areas greater than the geographical service areas of eNodeBs that are operating as the SSA base stations (second base station 14). Accordingly, a larger service area (LSA) eNodeB, such a macro eNodeB has a larger service area than a smaller service area (SSA) eNodeB such as a Micro eNodeB, Pico eNodeB, or Femto eNodeB. As discussed herein, a larger service area (LSA) base station is any type of base station or eNodeB that provides communication services within a larger service area than a smaller service area (SSA) base station where the SSA base station is any type of base station or eNodeB providing service within the smaller service area.

The hexagonal blocks representing the first LSA service area 102 and triangular blocks representing the fourth SSA service region 115 and the fifth SSA service region 117 include double crosshatching to indicate that at least one subcarrier frequency can be simultaneously used for downlink transmission from the LSA base station and the SSA base stations 132, 134 within the service regions 115, 117 at relatively high power weighting. The hexagonal blocks representing the second LSA service area 104 and the triangular blocks representing the sixth SSA service region 119 and the first SSA service region 109 include single crosshatching to indicate that at least one subcarrier frequency can be simultaneously used at a relatively high power weighting for downlink transmission from the LSA base station 122 and the SSA base stations 136, 126. The hexagonal blocks representing the third LSA service area 106 and the triangular blocks representing the second SSA service region 111 and the third SSA service region 113 do not include crosshatching to indicate that at least one subcarrier frequency can be simultaneously used at a relatively high power weighting for downlink transmissions from the LSA base station 124 and the SSA base stations 110, 112 in the regions 111, 113.

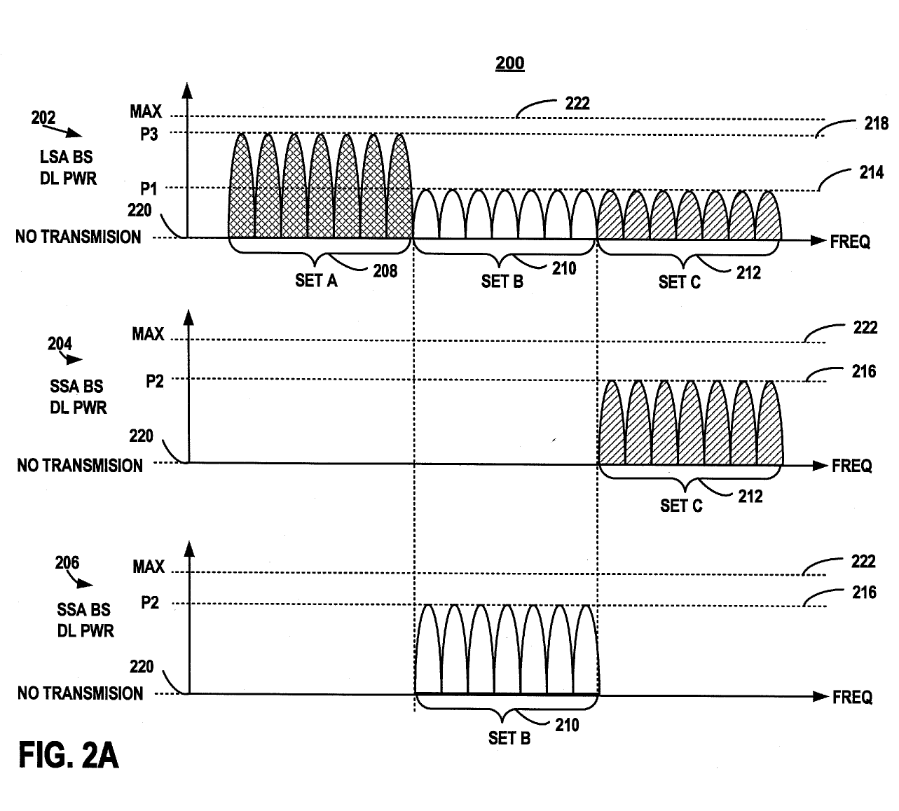

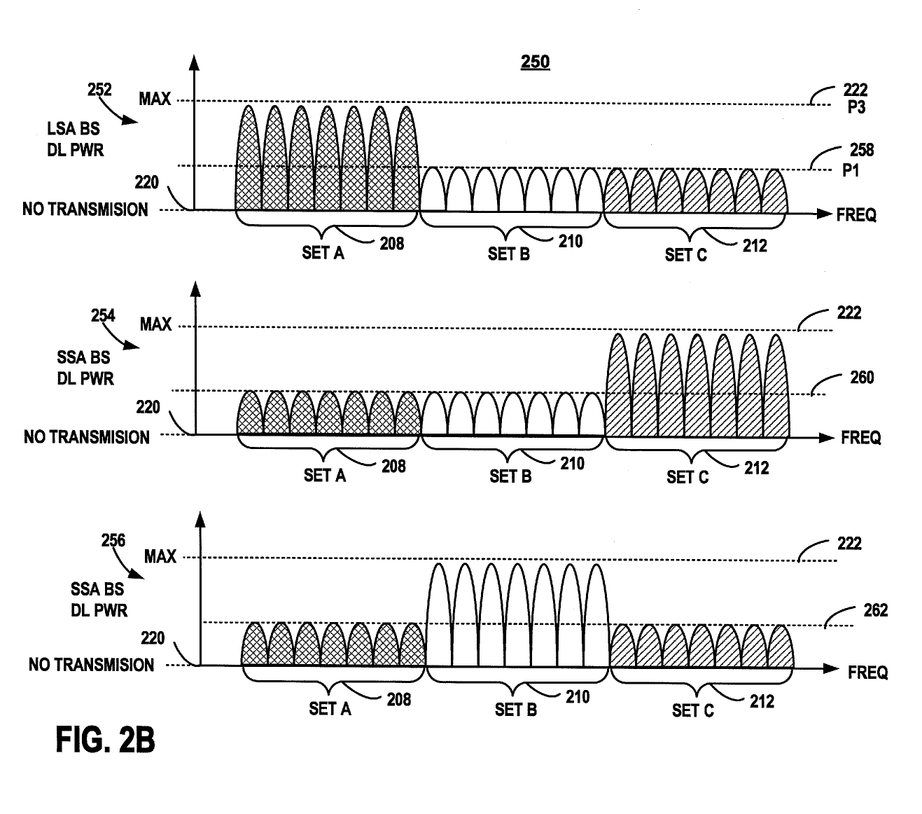

The LSA base stations can also simultaneously transmit at least one subcarrier at a frequency that is the same as the frequency used by a SSA base station having at least a partially overlapping service area with the service area of the LSA base station if the subcarrier transmitted from the LSA base station is transmitted at sufficiently low power weighting. Continuing with the example, therefore, the LSA base station 120 transmits one or more subcarriers at a relatively high power weighting where the SSA base stations 126, 128 simultaneously transmit subcarriers at the same frequency as the LSA highly weighted subcarriers only if the SSA base stations transmit the subcarriers at a relatively low power weighting. The SSA base stations 126, 128, however, can transmit subcarriers with higher power weightings power at frequencies where the LSA base station 120 simultaneously transmits subcarriers only at lower power weightings. An example of subcarrier power weighting is discussed with reference to FIG. 2A and FIG. 2B.

The service area deployment example of FIG. 1B, therefore, allows for power weighting of the subcarriers transmitted by SSA base stations based on the service region where the base stations are located. The power weighting of subcarriers from a SSA base station is based, at least partially, on the distance from the SSA base station to the LSA base stations. The power weighting is further based on the distance between the SSA base stations and the power weighting of the subcarriers of the other base stations in some circumstances.

FIG. 2A is a graphical representation 200 of an example of subcarrier transmissions 202, 204, 206 from a LSA base station and the SSA base stations having at least partially overlapping geographical service areas with the LSA geographical service area 102. The transmissions 202, 204, 206, for example, may be the transmissions of the first LSA base station 120, the first SSA base station 126 and the second SSA base station 128 of FIG. 1B. The plurality of subcarriers is divided into frequency sets labeled Set A 208, Set B 210, and Set C 212. Each set includes at least one subcarrier and may include any number of subcarriers. Therefore, the sets may include different numbers of subcarriers. Although in the example of FIG. 2A each set includes adjacent frequency subcarriers, each set may include subcarriers that are distributed within the entire frequency band.

In examples discussed herein, a power loading scheme is used to allocate power across the subcarriers. In accordance with OFDM techniques, power is allocated using power-loading techniques where power is increased over some subcarriers and decreased over others while maintaining a constant energy over the full frequency band although the overall power in the full frequency band can also be adjusted, in some circumstances. All subcarriers are transmitted as part of a single OFDM transmission for these examples. Accordingly, the drawings not showing subcarriers within certain frequency sets represent the situation where the subcarriers within those frequency sets are transmitted at a minimum power weighting.

The power allocation in power-loading systems can be expressed as xᵢ=αᵢsᵢ where αᵢ is a weight on the i-th subcarrier and sᵢ is the transmitted symbol (complex-valued). The vector α=[α₁, a₂, . . . , α_{N-1}, α_{N}]^{T} is designed to meet the following constraint:

$$E [ {\sum }_{i = 1}^{N} {\vert {α}_{i} {s}_{i} \vert}^{2} ] = {\sum }_{i = 1}^{N} {\vert {α}_{i} \vert}^{2} E [ {\vert {s}_{i} \vert}^{2} ] = ɛ and , \\ as a result , \\ {‖ α ‖}_{2} = {( {\sum }_{i = 1}^{N} {\vert {α}_{i} \vert}^{2} )}^{1 / 2} = 1$$

Various algorithms are applied to simultaneously adjust the corresponding bit-rate, Rᵢ (e.g. modulation order) and the power parameter, αₗ, for each subcarrier (or set of subcarriers) to optimize the system performance. Such a process is typically referred to as “loading” in OFDM systems.

Therefore, allocating various weights αᵢ in the frequency-domain allows power to be increased on certain parts of the frequency band while decreased on certain other parts of the frequency band. As mentioned above, however, the total base station (eNodeB) transmission power is fixed. Therefore, if power spectral density is increased on part of the bandwidth, less power is available for the remaining part of the bandwidth.

In typical OFDM based implementations, each base station performs power and bit-rate allocation per subcarrier (or a set of subcarriers) before the inverse fast Fourier transform (IFFT) operation (frequency-domain). Each base station may be assigned a different power level. Therefore, after IFFT operation, digital-to-analog and RF processing, each base station may transmit the signal at a different power level. Such a situation may occur where the base stations provide service in different sized service areas. A larger service area (LSA) base station is typically assigned a higher maximum power level than a smaller service area (SSA) base station. For example, during the final stages of transmission, a power amplifier of a macro base station transmits at 43 dBm and a power amplifier for a pico base station transmits at 30 dBm. The power amplifiers transmit a time-domain based signal where all frequencies are amplified. Due to power-allocation applied during the frequency-domain stage, however, each frequency gets amplified by a different factor. As exemplified herein, therefore, the assignment of a transmission power level (weighting) to subcarrier frequencies is at least partially accomplished by shifting power, in the frequency domain, to or from subcarriers. This procedure is referred to herein as subcarrier power weighting.

The graphical representation 200 is most illustrative of power weighting of subcarriers carrying information in the frequency domain before the IFFT operation, amplification, and transmission. Those skilled in the art will recognize the correspondence to the frequency spectrum in the time domain during transmission. In addition, the actual power of the transmitted signals may be further adjusted or determined by other factors. For example, the maximum power level of particular base stations may be limited to achieve a particular geographical coverage mapping. Accordingly, the illustrations in FIGS. 2A and 2B show the subcarrier power weightings which relate to relationships between the power levels of transmitted subcarriers. The power levels of the subcarrier depend on the power weightings and the transmission power of the particular base station. Two base stations with different transmission power, therefore, may transmit subcarriers at different power levels even though the same power weighting is used at both base stations.

The illustrations of FIG. 2A represent simultaneous subcarrier transmissions from three base stations over at least a portion of an OFDM frequency band. The shading of the shapes in FIG. 2A corresponds to the shading in FIG. 1B. The shapes representing the subcarriers, therefore, are drawn with no crosshatching, crosshatching, and double crosshatching to indicate the correspondence to FIG. 1B and assignment of frequency sets to the base stations. The LSA base station 120 transmits downlink signals over frequency Set A, frequency Set B, and frequency Set C where the subcarriers in set B and set C are transmitted at relatively lower power weighting (P1) 214. The first SSA base station 126 also transmits over subcarriers in frequency Set C. The downlink scheduler 40 assigns transmissions 202 from the LSA base station 120 over set B and set C to mobile wireless communication devices that are communicating with the LSA base station 120 through a channel with sufficiently high quality that allows communication with the lower power weighting (P1) 214. Therefore, a mobile wireless communication device 16 receiving downlink signals from the LSA base station 120 over subcarriers in a Set B or Set C channel is likely near the base station 120, has few signal obstructions in the signal path to the LSA base station 120, has few nearby signal interferers, or experiences conditions which are a combination thereof. Such a mobile wireless communication device can adequately receive signals transmitted over subcarriers in set B or set C at the lower power weighting (P1) 214. The lower power weighting (P1) 214, however, allows reuse of the subcarriers in set B and set C by the SSA base stations 126, 128 having service areas 108, 110 that at least partially overlap with the service area 102 of the LSA base station 120. Accordingly, the downlink scheduler 40 assigns one or more subcarriers in set B to the second SSA base station 128 and one or more subcarriers in the frequency set C to the first SSA base station 126 for transmission of signals from the SSA base stations to mobile wireless communication devices receiving signals from the SSA base stations. The carriers in Set B and Set C are set to a second power weighting (P2) 216.

The LSA base station 120 also transmits downlink signals over subcarriers in set A at a higher power weighting (P3) 218 than the lower power weighting (P1) 214 assigned to set B and set C. Set A subcarriers are used for mobile wireless communication devices 20 that are not communicating with the LSA base station 120 through a channel 44 that allows using the lower power weighting subcarriers. Therefore, these wireless communication devices may be positioned near the periphery of the LSA service area, may have signal obstructions with the path to the LSA base station, may be experiencing interference, or may have channel conditions based on combination of these circumstances as well as others. The first SSA base station and the second SSA base station do not transit within frequency set A when used by the LSA base station at the higher power weighting. The downlink scheduler 40 assigns the frequency sets to the appropriate base stations and mobile wireless communication devices to maximize channel quality while maximizing the efficient use of resources.

As discussed above, the transmissions shown in FIG. 2A are simultaneous transmissions. In addition to managing the power weightings of the subcarriers, however, the downlink scheduler may utilize time division multiplexing techniques where subcarriers are transmitted at a high power weighting from multiple base stations but at different times. For example, the SSA base station 126 may transmit on one or more subcarriers within Set A at a higher power weighting at times when the LSA base station 120 is not transmitting at the frequency of the subcarrier. The example of FIG. 2A shows no transmission on subcarriers sets other than single assigned set. In some circumstances, however, the SSA base stations may use subcarriers within the set used by the neighboring SSA station or the high weighting subcarrier assigned to the LSA base station as long as the power weighting is sufficiently low to avoid detrimental interference. For example, the SSA base station 126 may transmit within frequency set A and/or frequency set B in circumstances where the power weightings of the subcarriers are low enough to avoid interference with the subcarriers transmitted by the LSA base station 120 and the SSA base station 128 and where the transmissions from the LSA base station and SSA base station 128 do not interfere with the reception of the subcarriers transmitted by the SSA base station 126.

In some circumstances, therefore, the SSA base stations 126, 128 may simultaneously transmit downlink signals over frequency set A, frequency set B and/or frequency set C. In such circumstances, power weightings are assigned to each of the base stations to avoid detrimental interference while maintaining adequately robust channels for downlink communication. An example of subcarrier management where all frequency sets are used by each base station is discussed with reference to FIG. 2B below.

Therefore, the controller 38 selects a power weighting of the subcarriers for transmitting the signals 26, 30, 34 from each base station at power weights between a minimum power weighting 220, where the subcarriers can be viewed as not being transmitted, to a maximum power weight 222. Any of numerous factors, algorithms, and techniques may be used to determine the appropriate power weights. Power weighting techniques minimize noise and increase efficiency and capacity of the system. Examples of factors used for determining the power weighting may include the capacity of the system and base station loading factors in addition to the signal quality indicators in some circumstances. For the examples discussed herein, the relatively low power weighting such as P1 is set to a base level several dB down from the relatively high power weighting (such as P3). Where a fixed power weighting scheme is used, therefore, P1=P3−X dB where X is selected to provide a desired down link signal to interference ratio (DL SIR) experienced by mobile wireless communication devices under the predicted or reported conditions and circumstances. An example of a suitable value for X is 5 dB. In most situations, X will be at least 3 dB. For control signals, X is typically a fixed value and is selected to be either a maximum power weighting or minimum power weighting. In some circumstances where the downlink signals are transmitting data (e.g. non-control information such as voice and user data information), X is further based on the required or requested QoS of the particular mobile wireless communication device. For example, X for a voice over internet protocol (VOIP) application may be decreased in order to raise the relative power weighting of the subcarriers and X for the SMS application may be increased to lower the relative power weighting since the QoS demands are lower for the SMS application. Therefore, one technique for establishing the power weighting includes determining a minimum DL SIR threshold required for a mobile wireless communication device within a particular region and determining the power weightings required to achieve at least the minimum DL SIR threshold.

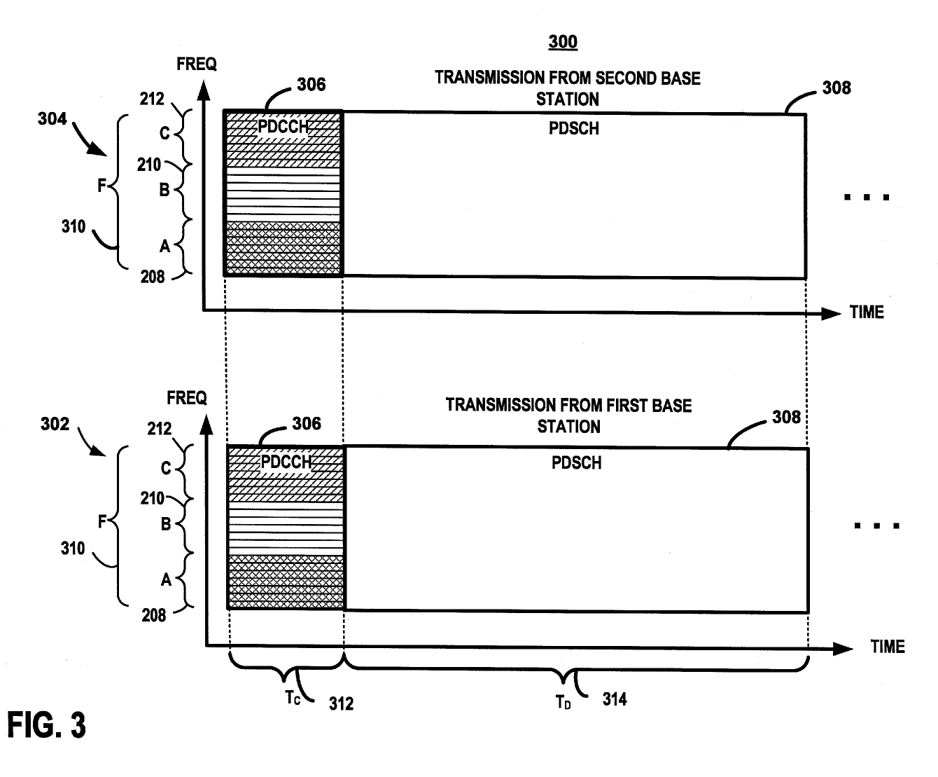

Although the subcarrier management techniques described above can be used for data or control signals, the techniques may be most suitable for control signals since control channels typically have a fixed coding rate and/or modulation order. An example of control signal transmissions with subcarrier management is discussed with reference to FIG. 3 below.

FIG. 2B is a graphical representation 250 of an example of subcarrier transmissions 252, 254, 256 from a LSA base station and the SSA base stations having at least partially overlapping geographical service areas with the LSA geographical service area 102 where each base station can simultaneously transmit subcarriers within all frequency sets 208, 210, 212. For the example of FIG. 2B, therefore, the SSA base stations transmit within Set A, Set B, and Set C although only subcarriers within one of the frequency sets are transmitted at a relatively higher power weighting. The LSA base station 120 transmits subcarriers within the second frequency set (Set B) 210 and the third frequency set (Set C) 212 at a power weighting P1 258 that is a fraction of the power weighting (P3) of the first frequency set (Set A) 208. For this example, the first power weighting P1 is 5 dB less than P3 which is at the maximum power weighting 222. The first SSA base station 126 transmits subcarriers within frequency Set A and Set B and power weighting 260 that is less than the power weighting of the subcarriers in frequency Set C 212. The second SSA base station 128 transmits subcarriers within frequency Set A and Set C and power weighting 262 that is less than the power weighting of the subcarriers in frequency Set B 210. For the example, the power weighting 260 is 5 db lower than the power weighting of Set C for the first SSA base station 126 and the power weighting 262 is 5 dB lower than power weighting of Set B for the second SSA base station 128. The power weighting of subcarriers within Set C from the first SSA base station 12 and the power weighting of subcarriers within Set B from the second SSA base station 128 are the maximum power weighting 222.

FIG. 3 is a graphical illustration 300 of transmissions 302, 304 from the base stations 12, 14 where the downlink subcarriers are managed for transmission of control information. For the example of FIG. 3, the transmissions 302, 304 are in accordance with a 3GPP LTE communication specification, the first base station is a LSA base station 120 such as a LSA eNodeB, and the second base station 14 is a SSA base station 126 such as a SSA eNodeB. Time-frequency resources are allocated for transmission of communication data and control data. In accordance with the communication standard, control information is transmitted within a Physical Downlink Control Channel (PDCCH) 306 and communication data is transmitted within a Physical Downlink Shared Channel (PDSCH) 308. In some situations, control channels may be allocated within the PDSCH 308. For the discussion herein, the subcarrier management is discussed with reference to the control information within the PDCCH. The techniques may be extended to control information transmitted with the PDSCH such as within the Broadcast Control Channel (BCH). The example of FIG. 3 corresponds to the example of FIG. 2A.

The device-specific control channel 306 has a frequency band (F) 310 and is allocated a transmission time period (T_{C}) 312. The data channel 308 is allocated the frequency band (F) 310 and another time period (T_{D}) 314. As discussed above, the frequency band (F) 310 is divided into multiple orthogonal subcarrier tones in accordance with OFDM techniques. Each channel time period is divided into frames, sub-frames, and symbols in accordance with the communication specification. The resources are further distributed between the wireless communication devices using coding.

The subcarriers used for the control channel 306 include the Set A 208, Set B 210, and the Set C 212 subcarriers. The shading of the frequency time resources shown in FIG. 3 corresponds to the shading in FIG. 1B and FIG. 2A.

The various frequencies and times shown FIG. 3 are only some examples of numerous allocation schemes. Resource elements may be allocated in other ways. Resource elements used for a particular channel may be contiguous or noncontiguous. Also, sizes of the blocks shown in FIG. 3 are selected to show a general relationship between the elements and are not necessarily to scale.

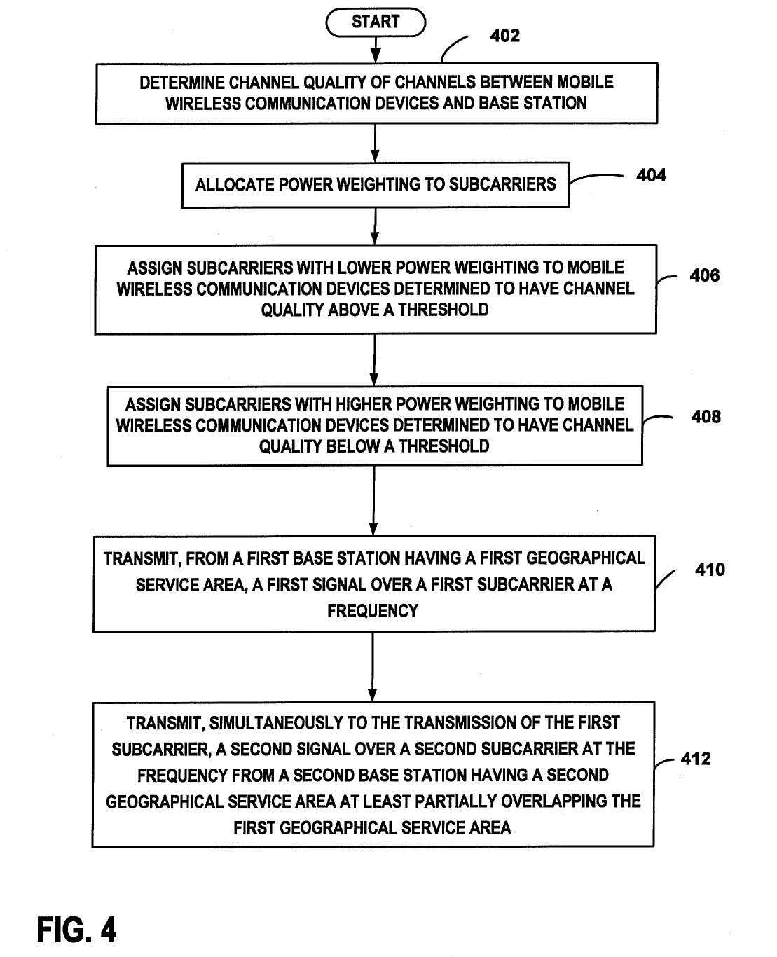

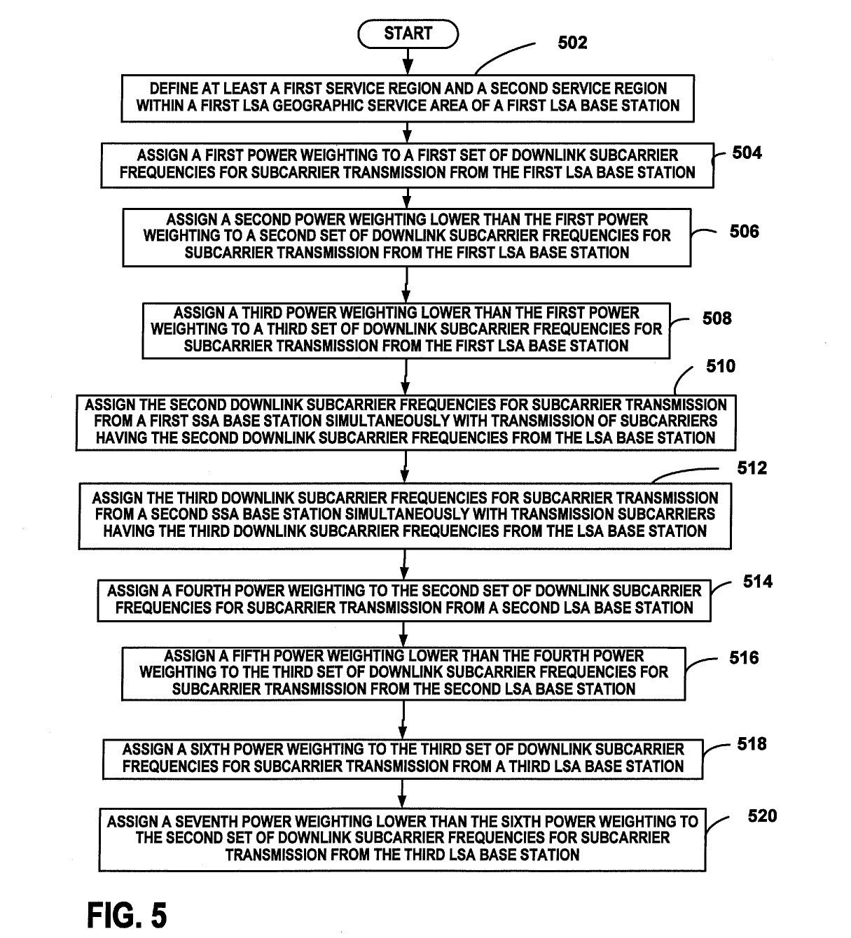

FIG. 4 is a flow chart of a method of managing downlink transmissions in an OFDM communication system. The method may be performed using a suitable combination of hardware, software, and/or firmware. The method is performed by a communication system such as the communication system 10 described herein. The described steps may be performed in a different order than shown in FIG. 4 and two or more steps may be performed simultaneously.

At step 402, the channel quality of the channels between the mobile wireless communication devices and the base station are determined. In the exemplary embodiment, the channel quality of the channel between the first base station and first mobile wireless communication device and the channel quality of another channel between the first base station and the third mobile wireless communication device are determined based on channel quality indicators in accordance with known techniques.

At step 404, power weighting is allocated to the subcarriers. In the exemplary embodiment, the plurality of subcarriers is divided into multiple sets and each set is assigned a power weighting. For the examples described herein, they are divided into three sets and each set is assigned either a higher power weighting or a lower power weighting for each base station. Any number of power weightings, however, may be used depending on the particular implementation.

At step 406, the subcarriers with a lower power weighting are assigned for transmission to mobile wireless communication devices determined to have a channel quality greater than a threshold value. A quality indicator such as BER, SNIR or other parameter may be compared to a quality indicator threshold. Subcarriers with lower power weightings are assigned for downlink transmission to mobile wireless communication devices 16 having sufficiently high quality channels 42 to the base station 12.

At step 408, the subcarriers with a higher power weighting are assigned for transmission to mobile wireless communication devices determined to have a channel quality less than a threshold value. A quality indicator such as BER, SNIR or other parameter may be compared to a quality indicator threshold. Subcarriers with higher power weightings are assigned for downlink transmission to mobile wireless communication devices 20 not having sufficiently high quality channels 44 to the base station 12. The threshold value may be same as or may be different from the threshold value used to identify mobile wireless communication devices having high quality channels.

At step 410, the first signal 26 is transmitted from the first base station 12 to the first mobile wireless communication device over a first subcarrier at the first frequency. For the example, the first subcarrier has a lower power weighting. As explained above, the first signal may be transmitted over several subcarriers where the subcarriers have a lower power weighting.

At step 412, the second signal 30 is transmitted from the second base station 14 over second subcarrier 32 at the first frequency. The second signal and the first signal are transmitted simultaneously using subcarriers having the same frequency. Since the first subcarrier is transmitted at lower power weighting, it does not significantly interfere with reception of the second signal by the second mobile wireless communication device 18.

FIG. 5 is a flow chart of a method of subcarrier management in a wireless communication system that included a plurality of larger service area (LSA) base stations and a plurality of smaller service area (SSA) base stations having SSA geographic service areas within LSA geographic service areas of the LSA base stations. The exemplary method results in subcarrier assignment and deployment in accordance with FIG. 1B.

At step 502, at least a first service region 109 and a second service region 111 within a first LSA service area 102 of a first LSA base station 120 are defined. Accordingly, the service area 102 is portioned into different regions. For the example, each LSa service area is divided into six regions.

At step 504, a first power weighting is assigned to a first set of downlink subcarrier frequencies 208 for subcarrier transmission from the first LSA base station 120.

At step 506, a second power weighting, lower than the first power weighting, is assigned to a second set of downlink subcarrier frequencies 210 for subcarrier transmission from the first LSA base station 120.

At step 508, a third power weighting, lower than the first power weighting, is assigned to a third set of downlink subcarrier frequencies 212 for subcarrier transmission from the first LSA base station 120. Although the third power weighting and the second power weighting may be different in some circumstances, the second and third power weighting are the same for this example.

At step 510, the second downlink subcarrier frequencies 210 are assigned for subcarrier transmission from a first SSA base station 126. The subcarrier transmission from first SSA base station 126 is simultaneous with transmission from the first LSA base station 120 of subcarriers having the second downlink subcarrier frequencies 210. The first SSA base station 126 has a first SSA service area 108 within the first service region 109.

At step 512, the third downlink subcarrier frequencies 212 are assigned for subcarrier transmission from a second SSA base station 128. The subcarrier transmission from the second SSA base station 128 is simultaneous with transmission from the first LSA base station 120 of subcarriers having the third downlink subcarrier 212 frequencies. The second SSA base station 128 has a second SSA service area 110 within the second service region 111.

At step 514, a fourth power weighting is assigned to the second set of downlink subcarrier frequencies 210 for subcarrier transmission from a second LSA base station 122. The second LSA base station 122 has a second LSA geographical service area 104 that is adjacent to the first LSA geographical service area 102.

At step 516, a fifth power weighting, lower than the fourth power weighting, is assigned to the third set of downlink subcarrier frequencies 212 for subcarrier transmission from the second LSA base station 122. The second service region 111 is adjacent to the second LSA geographical service area 104. Although the first power weighting and the fourth power weighting may be different in some circumstances, they are the same in this example and set to a maximum power weighting.

At step 518, a sixth power weighting is assigned to the third set of downlink subcarrier frequencies 212 for subcarrier transmission from a third LSA base station 124. The third LSA base station 124 has a third LSA geographical service area 106 adjacent to the first LSA geographical service area 102 and the second LSA geographical service area 104. Although the first power weighting and the sixth power weighting may be different in some circumstances, they are the same in this example and set to a maximum power weighting.

At step 520, a seventh power weighting, lower than the sixth power weighting, is assigned to the second set of downlink subcarrier frequencies 210 for subcarrier transmission from the third LSA base station 124. The first service region 109 is adjacent to the third LSA geographical service area 106.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

What is claimed is:

1. An orthogonal frequency division multiplex (OFDM) communication system comprising a plurality of base stations configured to transmit downlink signals over a plurality of subcarriers, the plurality of base stations comprising:
a first base station having a first geographical service area and configured to transmit a first signal over a first subcarrier at a frequency; and
a second base station having a second geographical service area at least partially overlapping the first geographical service area, the second base station configured to transmit, simultaneously to the transmission of the first subcarrier, a second signal over a second subcarrier at the frequency.

2. The OFDM communication system of claim 1, wherein the first subcarrier is transmitted by the first base station at a power weighting less than another power weighting of another subcarrier transmitted by the first base station.

3. The OFDM communication system of claim 2, further comprising a controller configured to assign the first subcarrier for transmissions to a mobile wireless communication device having a channel quality of a channel between the mobile wireless communication device and the first base station is above a threshold and further configured to assign the another subcarrier for transmissions to another mobile wireless communication device having another channel quality of another channel between the another mobile wireless communication device and the first base station is below the threshold.

4. The OFDM communication system of claim 3, wherein the power weighting is at least 3 dB lower than another power weighting.

5. The OFDM communication system of claim 1, wherein the first subcarrier is transmitted by the first base station at first power weighting and the second subcarrier is transmitted by the second base station at a second power weighting, the first power weighting and the second power weighting selected to maximize a quality of the first signal received at a first mobile communication device and to maximize a quality of the second signal received at a second mobile communication device positioned within the second geographical.

6. The OFDM communication system of claim 5, wherein the power weightings are selected to minimize interference between the subcarriers.

7. The OFDM communication system of claim 6, wherein the first base station is configured to transmit a third signal over a third subcarrier at a third frequency at a third power weighting, the third power weighting greater than the first power weighting.

8. The OFDM communication system of claim 7, wherein the first power weighting is at least 3 dB lower than the third power weighting.

9. A method of managing downlink transmissions in an orthogonal frequency division multiplex (OFDM) communication system, the method comprising:
transmitting, from a first base station having a first geographical service area, a first signal over a first subcarrier at a frequency; and
transmitting, simultaneously to the transmission of the first subcarrier, a second signal over a second subcarrier at the frequency from a second base station having a second geographical service area at least partially overlapping the first geographical service area.

10. The method of claim 9, further comprising:
determining that a channel quality of a channel between a mobile wireless communication device and the first base station is above a threshold;
determining that another channel quality of another channel between another mobile wireless communication device and the first base station is below a threshold;
assigning the first subcarrier for transmissions to the mobile wireless communication device; and
assigning another subcarrier for transmissions to the another mobile wireless communication device.

11. The method of claim 10, wherein the transmitting the first subcarrier comprises transmitting the first subcarrier at a power weighting less than another power weighting of another subcarrier transmitted by the first base station.

12. The method of claim 11, wherein the power weighting is at least 3 dB less than the another power weighting.

13. The method of claim 9, wherein:
transmitting the first subcarrier comprises transmitting the first subcarrier at a first power weighting;
transmitting the second subcarrier comprises transmitting the second subcarrier at a second power weighting; and
selecting the first power weighting and the second power weighting to maximize a quality of the first signal received at a first mobile wireless communication device and to maximize a quality of the second signal received at a second mobile wireless communication device positioned within the second geographical service area.

14. The method of claim 13, further comprising transmitting, from the first base station, a third signal over a third subcarrier at a third frequency at a third power weighting, the third power weighting greater than the first power weighting.

15. The method of claim 14, wherein the first power weighting is at least 3 dB lower than the third power weighting.

16. A downlink scheduler for managing downlink transmissions in an orthogonal frequency division multiplex (OFDM) communication system, the downlink scheduler comprising electronics configured to:
determine that a channel quality of a channel between a mobile wireless communication device and a first base station is above a threshold;
determine that another channel quality of another channel between another mobile wireless communication device and the first base station is below the threshold;
assign a first subcarrier at a frequency for a first signal transmission to the mobile wireless communication device from the first base station having a first geographical service area;
assign another subcarrier at another frequency for another signal transmission to the another mobile wireless communication device from the first base station; and
assign a second subcarrier at the frequency for a second signal transmission to a second mobile wireless communication device from a second base station having a second geographical service area at least partially overlapping the first geographical service area, the second signal transmission scheduled for simultaneous transmission with the first signal transmission.

17. A smaller service area (SSA) base station having a geographical service area within a larger geographical service area of a larger service area (LSA) base station, the SSA base station comprising:
a transmitter configured to transmit a plurality of subcarriers within a frequency band in accordance with orthogonal frequency division multiplex (OFDM) techniques, wherein a power weighting scheme applied to the plurality of subcarriers distributes total power within the frequency band to increase power of at least one subcarrier relative to one other subcarrier of the plurality of subcarriers, the power weighting scheme based on at least a distance between the LSA base station and the SSA base station.

18. The SSA base station of claim 17, wherein the power weighting scheme is further based on a LSA power weighting scheme of the LSA base station.

19. A method of subcarrier management in a wireless communication system comprising a plurality of larger service area (LSA) base stations and a plurality of smaller service area (SSA) base stations having SSA geographic service areas within LSA geographic service areas of the LSA base stations, the method comprising:
defining at least a first service region and a second service region within a first LSA geographic service area of a first LSA base station;
assigning a first power weighting to a first set of downlink subcarrier frequencies for subcarrier transmission from the first LSA base station;
assigning a second power weighting lower than the first power weighting to a second set of downlink subcarrier frequencies for subcarrier transmission from the first LSA base station;
assigning a third power weighting lower than the first power weighting to a third set of downlink subcarrier frequencies for subcarrier transmission from the first LSA base station;
assigning the second downlink subcarrier frequencies for subcarrier transmission from a first SSA base station simultaneously with transmission of subcarriers having the second downlink subcarrier frequencies from the LSA base station, the first SSA base station having a first SSA service area within the first service region; and
assigning the third downlink subcarrier frequencies for subcarrier transmission from a second SSA base station simultaneously with transmission subcarriers having the third downlink subcarrier frequencies from the LSA base station, the second SSA base station having a second SSA service area within the second service region.

20. The method of claim 19, further comprising:
assigning a fourth power weighting to the second set of downlink subcarrier frequencies for subcarrier transmission from a second LSA base station having a second LSA geographical service area adjacent to the first LSA geographical service area; and
assigning a fifth power weighting lower than the fourth power weighting to the third set of downlink subcarrier frequencies for subcarrier transmission from the second LSA base station, wherein the second service region is adjacent to the second LSA geographical service area.

21. The method of claim 20, further comprising:
assigning a sixth power weighting to the third set of downlink subcarrier frequencies for subcarrier transmission from a third LSA base station having a third LSA geographical service area adjacent to the first LSA geographical service area and the second LSA geographical service area; and
assigning a seventh power weighting lower than the sixth power weighting to the second set of downlink subcarrier frequencies for subcarrier transmission from the third LSA base station, wherein the first service region is adjacent to the third LSA geographical service area.
